(19) United States
(12) Patent Application Publication
(10) Pub. No.: US 2025/0230902 A1
(43) Pub. Date: Jul. 17, 2025

(54) CALCULATION METHOD FOR CALCULATING DIMENSIONS OF SPACER ELEMENTS FOR THE CONSTRUCTION OF A LIQUID-PRODUCT STORAGE FACILITY

(71) Applicant: GAZTRANSPORT ET TECHNIGAZ, SAINT-REMY-LES-CHEVREUSE (FR)

(72) Inventors: Michael COURTOT, SAINT-REMY-LES-CHEVREUSE (FR); Othman LAMDOUAR, SAINT-REMY-LES-CHEVREUSE (FR); Mikael VOLUT, SAINT-REMY-LES-CHEVREUSE (FR); Yann VOLUT, SAINT-REMY-LES-CHEVREUSE (FR)

(21) Appl. No.: 18/704,497

(22) PCT Filed: Oct. 28, 2022
(86) PCT No.: PCT/EP2022/080254

§ 371 Date: Apr. 25, 2024

(30) Foreign Application Priority Data
Oct. 29, 2021 (FR) FR2111579

(51) Int. Cl. F17C 13/02; F17C 3/02

(52) U.S. Cl. CPC F17C 13/02; F17C 3/022; F17C 2201/0104; F17C 2250/0478

(57) ABSTRACT

The invention relates to a calculation method (400) for calculating dimensions of spacer elements (40) intended for the construction of a liquid-product storage facility (1), the storage facility comprising a load-bearing structure (10) having an internal space (11) delimited by a load-bearing wall (12) and a sealed tank (20) installed in the internal space (11) of the load-bearing wall (12).

The calculation method (400) is based on an iterative decrease in the dimensions of the spacer elements (40) under the constraint of acceptability criteria, the acceptability criteria comprising planarity criteria limiting deformations of planar facets (224) of the tank (20).

### TECHNICAL FIELD

The invention relates to the construction of a liquid-product storage facility. More particularly, the invention relates to the calculation of dimensions of spacer elements intended for the construction of a liquid-product storage facility, the storage facility comprising a load-bearing structure having an internal space delimited by a load-bearing wall and a sealed tank installed in the internal space of the load-bearing wall.

The tank can be a sealed and thermally insulating tank for storing and/or transporting liquefied gas at low temperature, such as tanks for transporting liquefied petroleum gas (LPG) having for example a temperature of between −50° C. and 0° C., or for transporting liquefied natural gas (LNG) at approximately −162° C. at atmospheric pressure. These tanks can be installed on shore or on a floating structure. In the case of a floating structure, the tank may be intended for transporting liquefied gas or for receiving liquefied gas used as fuel to propel the floating structure.

In one embodiment, the liquefied gas is LNG, namely a mixture with a high methane content stored at a temperature of around −162° C. at atmospheric pressure. Other liquefied gases may also be envisaged, notably ethane, propane, butane or ethylene, but also hydrogen. Liquefied gases may also be stored under pressure, for example at a relative gauge pressure of between 2 and 20 bar, and in particular at a relative gauge pressure of around 2 bar. The tank may be produced using various techniques, notably in the form of an integrated membrane tank or of a self-supporting tank.

The sealed tank may alternatively be a sealed tank for storing and/or transporting a liquid product, such as crude oil or refined oil, notably kerosene, diesel or gasoline, at ambient pressure and at ambient temperature.

### PRIOR ART

Document WO 2020/193584 A1 discloses a method for constructing a sealed and thermally insulating tank in a load-bearing structure. A plurality of insulating blocks are juxtaposed and anchored on the inner surface of the load-bearing wall. Shims and beads of mastic are disposed between the insulating blocks and the load-bearing wall. The shims and beads of mastic make it possible to compensate for the planarity defects of the inner surface of the load-bearing structure, and thus to provide a thermally insulating barrier having a satisfactory planarity for supporting the sealed membrane of the tank.

### SUMMARY OF THE INVENTION

One idea underlying the invention is that of providing a calculation method for calculating dimensions of spacer elements intended for the construction of a liquid-product storage facility, the storage facility comprising a load-bearing structure having an internal space delimited by a load-bearing wall and a sealed tank installed in the internal space of the load-bearing wall. Another idea underlying the invention is that of calculating the dimensions of the spacer elements in an iterative manner, more precisely by iteratively decreasing these dimensions under the constraint of acceptability criteria, the acceptability criteria comprising planarity criteria limiting deformations of planar facets comprised by the tank.

The invention thus proposes a calculation method for calculating dimensions of spacer elements intended for the construction of a liquid-product storage facility, the storage facility comprising a load-bearing structure having an internal space delimited by a load-bearing wall and a sealed tank installed in the internal space of the load-bearing wall, the calculation method being implemented by computer and comprising:
obtaining position measurements of the load-bearing wall in three dimensions;
on the basis of said position measurements, defining, in the internal space of the load-bearing structure, an initial position of the tank, the initial position of the tank comprising an initial position for the peripheral wall of the tank, the peripheral wall having, in the initial position, a plurality of planar facets forming a polygonal cylindrical surface having as directrix a convex polygon and a generatrix perpendicular to the directrix; and
for each planar facet:
   defining positioning lines defining locations of juxtaposed wall modules intended to form the peripheral wall of the tank;
   on the basis of the positions of the positioning lines, defining setting lines extending perpendicularly with respect to the planar facet between the planar facet and the load-bearing wall, the setting lines being disposed such that at least one setting line intersects each of the locations of the wall modules, said setting lines representing the positions of spacer elements intended to be disposed between each wall module and the load-bearing wall in a final position of the peripheral wall of the tank;
   calculating initial dimensions of the setting lines on the basis of the position measurements of the load-bearing wall;
   iteratively decreasing the dimensions of the setting lines so as to bring the wall modules closer to the load-bearing wall up to the final position of the peripheral wall of the tank, the iterative decrease being carried out under the constraint of acceptability criteria, the acceptability criteria comprising planarity criteria limiting deformations of the planar facets.

By virtue of these features, the calculation of the dimensions of the spacer elements is carried out in such a way as to decrease the dimensions of the spacer elements as much as possible, and therefore to decrease a lost volume between the peripheral wall of the tank and the load-bearing wall, as long as acceptability criteria are verified. The acceptability criteria limit the deformations of the planar facets and thus ensure that the peripheral wall of the tank in its final position has a sufficient planarity, for example for supporting a sealing membrane.

The calculation method is implemented by computer, for example by a suitable computer program executed by a computer. A user can thus obtain the dimensions of the spacer elements in an automatic manner, without human intervention apart from potentially to specify the acceptability criteria beforehand. The position measurements may be fully or partly input manually by the user, or may be provided to the computer program in a computer-readable format.

According to embodiments, such a calculation method may have one or more of the following features.

According to one embodiment, iteratively decreasing the dimensions of the setting lines comprises:
a) selecting a setting line;
b) decreasing the dimension of the selected setting line down to a reduced dimension;
c) verifying by the calculation that the acceptability criteria are verified, and: if so, maintaining the reduced dimension obtained in step b); if not, canceling the decrease in dimension carried out in step b);
d) verifying whether there is at least one setting line that has not yet been selected, and if so, carrying out steps a) to c) on a said setting line that has not yet been selected; if not, verifying whether the reduced dimension has been maintained in step c) for at least one setting line, and: if so, carrying out steps a) to d) again; if not, recording in a memory the dimensions of the setting lines as dimensions of the spacer elements.

According to one embodiment, the dimensions of the setting lines are decreased by a predetermined increment.

According to one embodiment, the acceptability criteria comprise a lower limit criterion according to which the dimensions of the setting lines remain greater than or equal to a first predefined lower limit.

According to one embodiment, the acceptability criteria comprise a spacing criterion according to which a distance between each wall module and the load-bearing wall, perpendicularly with respect to said wall module, remains greater than or equal to a second predefined lower limit.

According to one embodiment, the acceptability criteria comprise a slope criterion relating to the slope difference between the apexes of three aligned neighboring spacer elements.

According to one embodiment, the acceptability criteria comprise a torsion criterion relating to the spacings between each wall module in line with the spacer elements and a mean plane of said wall module, perpendicularly with respect to said wall module.

According to one embodiment, defining said initial position of the peripheral wall of the tank comprises defining reference values for angles formed by said planar facets at corner edges separating said planar facets.

According to one embodiment, the peripheral wall of the tank is completely formed of juxtaposed planar wall modules, and the acceptability criteria comprise an angle criterion according to which an angle formed by two slopes connecting the apexes of the two aligned spacer elements closest to a corner edge, on either side of said corner edge, is comprised within a range including the reference value for the angle at said corner edge.

According to one embodiment, the wall modules comprise, at one of said corner edges, dihedral wall modules that are disposed at said corner edge and exhibit a dihedron, the angle of which is equal to the reference value for the angle at said corner edge, and the acceptability criteria comprise a second slope criterion relating to a slope difference between, on the one hand, a slope between the apex of a spacer element corresponding to the dihedral block and the apex of an adjacent spacer element, and, on the other hand, a slope between the apex of said spacer element corresponding to the dihedral block and a point situated on the dihedron of the dihedral block and aligned with said spacer elements.

According to one embodiment,
the load-bearing structure further comprises a planar bottom load-bearing wall having dimensional tolerances;
obtaining position measurements of the load-bearing wall in three dimensions further comprises obtaining position measurements of the bottom load-bearing wall in three dimensions;
the initial position of the tank further comprises a bottom planar facet defining an initial position for a bottom wall of the tank;
the calculation method further comprises:
   defining, on the basis of the positioning lines, bottom positioning lines defining locations of juxtaposed bottom wall modules intended to form the bottom wall of the tank;
   on the basis of the positions of the bottom positioning lines, defining bottom setting lines extending perpendicularly with respect to the bottom planar facet between the bottom planar facet and the bottom load-bearing wall, the bottom setting lines being disposed such that at least one bottom setting line intersects each of the locations of the bottom wall modules, said bottom setting lines representing the positions of spacer elements intended to be disposed between each bottom wall module and the bottom load-bearing wall in a final position of the bottom wall of the tank;
   calculating initial dimensions of the bottom setting lines on the basis of the position measurements of the bottom load-bearing wall;
   iteratively decreasing the dimensions of the bottom setting lines so as to bring the wall modules closer to the bottom load-bearing wall up to the final position of the bottom wall of the tank, the iterative decrease being carried out under the constraint of acceptability criteria, the acceptability criteria comprising planarity criteria limiting deformations of the bottom planar facet.

According to one embodiment, the wall modules intended to form the peripheral wall of the tank have a rectangular outer contour, the positioning lines define rectangular locations for the wall modules, and the setting lines are disposed such that at least four setting lines intersect each of the rectangular locations of the wall modules in the vicinity of the corners of the rectangular locations.

According to one embodiment, the wall modules comprise means for retaining at least one metal sheet intended to constitute a sealing membrane of the tank.

According to one embodiment, the tank is a sealed and thermally insulating tank.

According to one embodiment, the wall modules are thermally insulating blocks.

According to one embodiment, the thermally insulating blocks each comprise a block of polymer foam sandwiched between a cover sheet and a bottom sheet. According to one embodiment, the block of polymer foam is a block of polyurethane foam optionally reinforced with glass fibers. According to one embodiment, the polymer foam has a density of between 130 and 200 kg/m³. According to one embodiment, the cover sheet and the bottom sheet are made of plywood.

According to one embodiment, the cover sheet has an anchor plate, the anchor plate being intended to be welded to an edge of a metal sheet for retaining the metal sheet on the cover sheet.

According to one embodiment, the peripheral wall of the tank has, in the initial position, a plurality of planar facets forming a polygonal cylindrical surface having as directrix a regular convex polygon.

According to one embodiment, the load-bearing wall forms a polygonal or circular cylindrical surface having dimensional tolerances.

According to one embodiment, the spacer elements comprise shims.

According to one embodiment, the spacer elements comprise anchor rods. According to one embodiment, the anchor rods retain the wall modules on the load-bearing wall.

According to one embodiment, obtaining position measurements of the load-bearing wall in three dimensions comprises carrying out a three-dimensional survey of the position of the vertical load-bearing wall with the aid of a scanning laser rangefinder.

According to one embodiment, the three-dimensional survey is carried out with a resolution equal to a point every 2 cm² or less.

### BRIEF DESCRIPTION OF THE FIGURES

The invention will be better understood, and further aims, details, features and advantages thereof will become more clearly apparent, in the course of the following description of several particular embodiments of the invention, which are given solely by way of non-limiting illustration, with reference to the appended drawings.

FIG. 1A is a diagram showing an initial position for a peripheral wall of a tank in the internal space of a load-bearing structure.

FIG. 1B is a diagram identical to FIG. 1A, showing the shape of the load-bearing structure according to one variant.

FIG. 2 is a diagram showing part of a main load-bearing wall of the load-bearing structure, a planar facet of the peripheral wall of the tank in the initial position, and the initial dimensions of setting lines in the initial position in FIG. 1A.

FIG. 3 is a diagram similar to FIG. 2, showing the dimensions of setting lines in a final position of the peripheral wall of the tank wall.

FIG. 4A is a block diagram showing the steps of a calculation method according to the invention.

FIG. 4B is a block diagram showing one of the steps of the calculation method in FIG. 4A in detail.

FIG. 5 is a diagram showing one way of defining the initial dimensions of the setting lines.

FIG. 6 is a diagram showing juxtaposed planar wall modules intended to form the peripheral wall of the tank and spacer elements intended to be disposed between each wall module and the load-bearing wall in the final position of the peripheral wall of the tank.

FIG. 7 is another diagram showing juxtaposed planar wall modules and spacer elements.

FIG. 8A is a diagram showing the locations of the setting lines shown in FIGS. 3A, 3B and 5 and of the positioning lines defining the locations of the planar wall modules.

FIG. 8B is a diagram showing slopes between the apexes of aligned neighboring spacer elements.

FIG. 9 is a diagram showing a mean plane of a planar wall module and spacings between the wall module in line with the spacer elements and the mean plane, perpendicularly with respect to said wall module.

FIG. 10 is a diagram showing slopes between the apexes of aligned neighboring spacer elements on either side of a corner edge separating two planar walls of the tank.

FIG. 11 is a diagram showing a first embodiment variant of the peripheral wall of the tank, in which the spacer elements are shims.

FIG. 12 is a diagram showing a possible structure for the wall modules in the first embodiment variant.

FIG. 13 is a diagram showing the peripheral wall of the tank in the first embodiment variant, at a corner edge separating two planar walls of the tank.

FIG. 14 is a partial view in section showing a second embodiment variant of the peripheral wall of the tank, in which the spacer elements are anchor rods.

FIG. 15A is a diagram showing a possible structure of the peripheral wall of the tank in the second embodiment variant, at a corner edge separating two planar walls of the tank.

FIG. 15B is a diagram illustrating a virtual transformation of a dihedral block into a planar block.

FIG. 15C is a diagram illustrating a calculation of a position of a point situated on the dihedron of the dihedral block in FIGS. 15A and 15B.

FIG. 15D is a diagram similar to FIG. 15C, showing slopes between the apexes of aligned neighboring spacer elements and between the apexes of these spacer elements and of the point situated on the dihedron of the dihedral block in FIGS. 15A and 15B.

FIG. 16 is a partial perspective view of the load-bearing structure, showing part of a bottom wall of the load-bearing structure and part of the main load-bearing wall of the load-bearing structure.

FIG. 17 is a diagram showing slopes between the apexes of aligned neighboring spacer elements on either side of a corner edge separating the bottom wall and the main load-bearing wall of the load-bearing structure.

### DESCRIPTION OF THE EMBODIMENTS

As mentioned above, the invention is concerned with producing a liquid-product storage facility, which bears the reference 1 in the description that follows.

According to one variant, the facility 1 is capable of storing a liquefied gas, in particular liquefied natural gas (LNG) at a temperature of around −162° C. and at atmospheric pressure or other liquefied gases. According to another variant, the facility 1 is capable of storing a different liquid product, such as crude oil or refined oil, notably kerosene, diesel or gasoline.

The facility 1 primarily comprises a load-bearing structure 10 and a sealed tank 20.

The load-bearing structure 10 will be described first of all. The load-bearing structure 10 comprises at least one load-bearing wall which defines a cavity intended to receive the sealed tank 20. In one embodiment, a main load-bearing wall 12 has a roughly cylindrical geometry which surrounds the cavity. Such a main load-bearing wall 12 may also be closed by another load-bearing wall at at least one end in the guiding direction. In one embodiment, such a main load-bearing wall 12 may extend between a bottom load-bearing wall and a cover load-bearing wall.

The facility 1 may be provided so as to be situated on shore. The main load-bearing wall 12 is then typically vertical, that is to say situated in a plane parallel to the direction of acceleration due to gravity within the dimensional tolerances. The load-bearing structure 10 is for example made of concrete. In a manner that is not shown in the drawings, the bottom load-bearing wall may be situated on the ground or potentially below ground level. In a manner that is not shown in the drawings, at that end of the main load-bearing wall 12 which is opposite the bottom load-bearing wall, the load-bearing structure 10 comprises a cover load-bearing wall closing the internal space delimited by the bottom load-bearing wall and the vertical load-bearing wall 12. This cover load-bearing wall may support various items of equipment that can be used to convey the liquid product from or to this internal space. The bottom load-bearing wall and/or the cover load-bearing wall may for example be planar. However, other shapes are possible for the bottom load-bearing wall and the cover load-bearing wall, notably spherical dome shapes.

As an alternative, the facility 1 may be provided so as to be installed on board a floating structure, such as a ship. In this case, the load-bearing structure 10 is a portion of a double hull comprised by the floating structure. The main load-bearing wall 12 may potentially be non-vertical, and even have a guiding direction perpendicular to the direction of acceleration due to gravity when the floating structure is at rest.

Hereinafter, consideration will more particularly be given to the case of a facility 1 which is situated on shore and in which the main load-bearing wall 12 is vertical. Reference will thus hereinafter be made to a vertical load-bearing wall 12. It is nevertheless specified that the description that follows applies to any orientation of the main load-bearing wall 12 with respect to the direction of acceleration due to gravity.

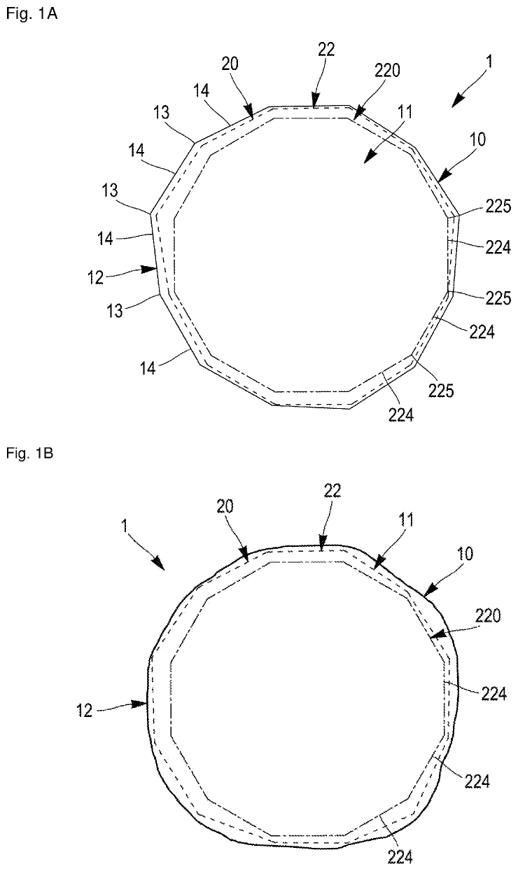

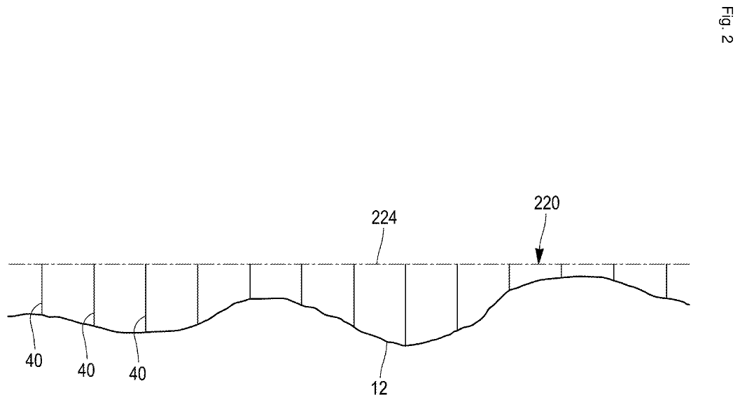

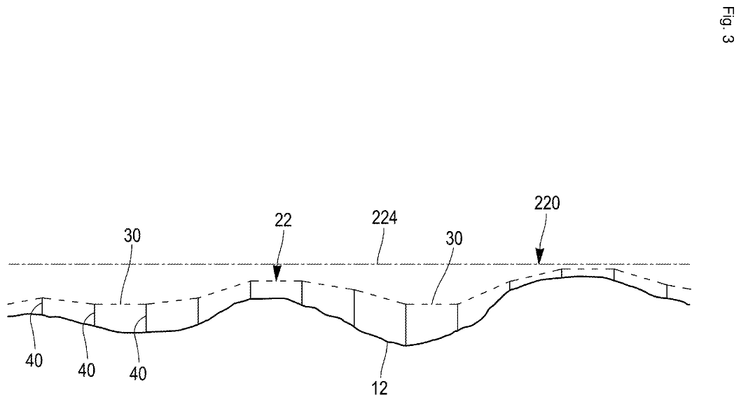

FIG. 1A is a schematic view in section of the load-bearing structure 10, taken perpendicularly with respect to a vertical axis of the vertical load-bearing wall 12. The vertical load-bearing wall 12 is shown as a solid line in FIG. 1A. The vertical load-bearing wall 12 forms a polygonal cylindrical surface and has typically been constructed using civil engineering techniques. Thus, the vertical load-bearing wall 12 has vertical panels 14 separated from one another by corner edges 13. The position and the orientations of the vertical panels 14 may exhibit dimensional deviations with respect to a provided regular polygonal shape. Furthermore, as shown in FIG. 2, each vertical panel 14 may exhibit dimensional deviations with respect to a planar ideal shape. These dimensional deviations may, for example, be due to dimensional tolerances on a concrete construction.

In a variant, as shown in FIG. 1B, the vertical load-bearing wall 12 may form any convex cylindrical surface, for example a vaguely circular one whilst still exhibiting dimensional deviations with respect to a circle shape. Such a load-bearing wall may be a natural cavity or a construction having high tolerances. However, more generally, the vertical load-bearing wall 12 may have a shape that is less regular or more regular than the shapes illustrated.

The sealed tank 20 (in dashed lines in FIGS. 1A and 1B) is intended to be installed in the internal space 11 of the load-bearing structure 10. The tank 20 comprises a vertical peripheral wall 22 intended to face the vertical load-bearing wall 12. In a manner that is not shown in the drawings, the tank 20 further comprises a bottom wall facing the bottom load-bearing wall and a cover wall facing the cover load-bearing wall.

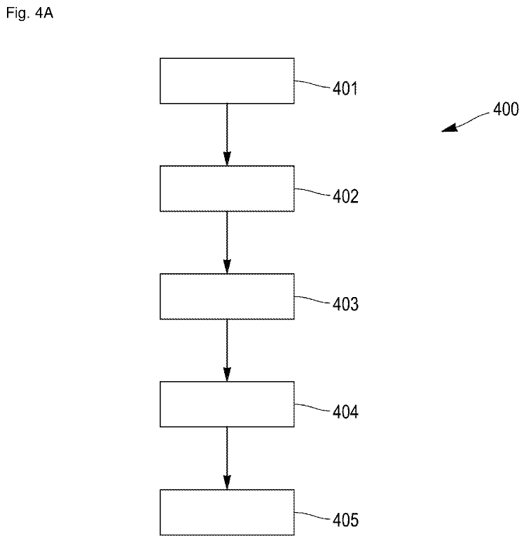

The vertical peripheral wall 22 is formed of juxtaposed planar wall modules 30. The edge of the wall modules 30 which is closest to the vertical load-bearing wall 12 is shown in dashed lines in FIG. 3. Typically, the wall modules 30 are disposed in parallel and vertical rows. Spacer elements 40 are disposed between the wall modules 30 and the vertical load-bearing wall 12 in order to compensate for the aforementioned dimensional deviations.

The spacer elements 40 should be provided with the smallest possible dimensions, in order to maximize the internal volume of the tank and to minimize the quantity of material to be disposed between the vertical load-bearing wall 12 and the vertical peripheral wall 22, whilst still ensuring that the vertical peripheral wall 22 has a sufficient planarity for supporting a sealed membrane sealing the tank 20.

Before a calculation method 400 which makes it possible to achieve these objectives is described, the overall principle will be explained with reference to FIGS. 1A, 1B, 2 and 3. In these figures, an initial position 220 of the vertical peripheral wall 22 is shown in dash-dotted lines. It is specified that the distance between the initial position 220 and the vertical load-bearing wall 12 has been greatly exaggerated in FIGS. 1A and 1B in order to facilitate the legibility of the drawing.

The initial position 220 meets certain acceptability criteria which are described below. The initial position 220 is thus considered to be acceptable for ensuring that the vertical peripheral wall 22 has a sufficient planarity. However, the initial position 220 leaves a significant space between the vertical peripheral wall 22 and the vertical load-bearing wall 12. This has the result that if the vertical peripheral wall 22 were naively positioned in the initial position 220, as shown in FIG. 2, the dimensions of the spacer elements 40 would be significant. Furthermore, if the construction of the tank 20 requires material to be disposed between the vertical load-bearing wall 12 and the vertical peripheral wall 22 in order to ensure the mechanical strength thereof, the volume of material used would be significant.

Conversely, at the end of the calculation method 400, reduced dimensions of the spacer elements 40 in a final position 320 of the vertical peripheral wall 22 have been found. The final position 320 meets the same acceptability criteria as the initial position 220 and thus still ensures that the vertical peripheral wall 22 has a sufficient planarity. However, since the dimensions of the spacer elements 40 have been reduced, the volume of material to be disposed between the vertical load-bearing wall 12 and the vertical peripheral wall 22 is decreased, and the internal volume of the tank 20 is increased.

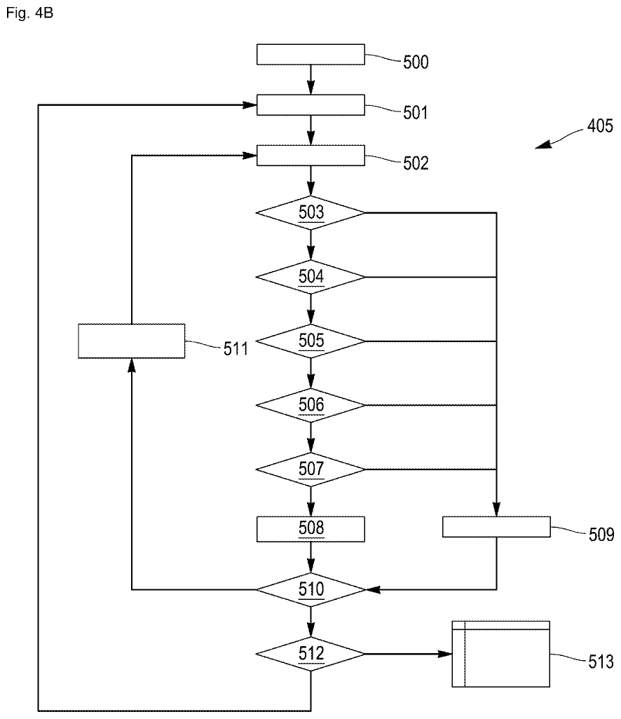

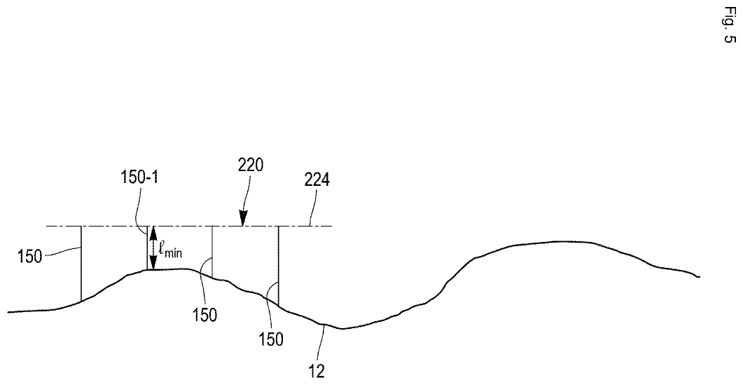

The steps of the calculation method 400 will now be described with reference to FIGS. 4A to 10.

The method 400 comprises a step 401 consisting in obtaining position measurements of the vertical load-bearing wall 12 in three dimensions. According to a particular example, this step 401 consists in carrying out a three-dimensional survey of the position of the vertical load-bearing wall 12 with a high resolution, for example equal to a point every 2 cm² or less, with the aid of a scanning laser rangefinder.

In a step 402, on the basis of the position measurements obtained in step 401, the initial position 220 of the vertical peripheral wall 22 of the tank 20 is defined in the internal space 11. In the initial position 220, the vertical peripheral wall 22 has a plurality of planar facets 224 forming a polygonal cylindrical surface having as directrix a convex polygon and a generatrix perpendicular to the directrix. In a particular variant, the polygonal cylindrical surface formed by the planar facets 224 has as directrix a regular convex polygon. According to a particular example, the initial position 220 is obtained by searching for a position of the vertical peripheral wall 22 by numerical simulation under the constraint of one or more criteria, which may for example include a criterion for minimizing the space which exists between the vertical peripheral wall 22 of the tank 20 and the vertical load-bearing wall 12.

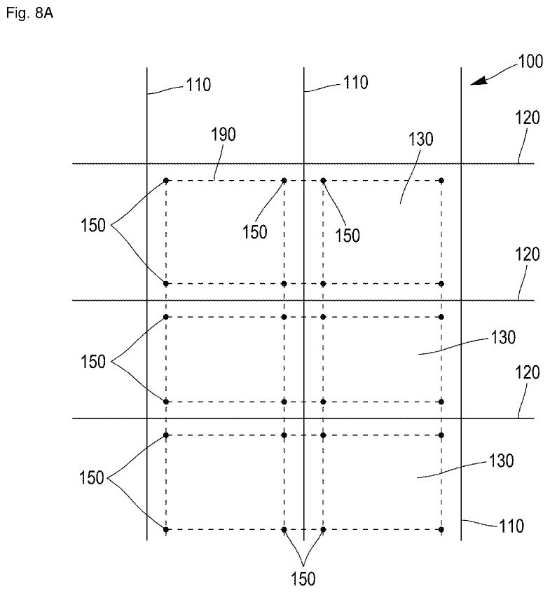

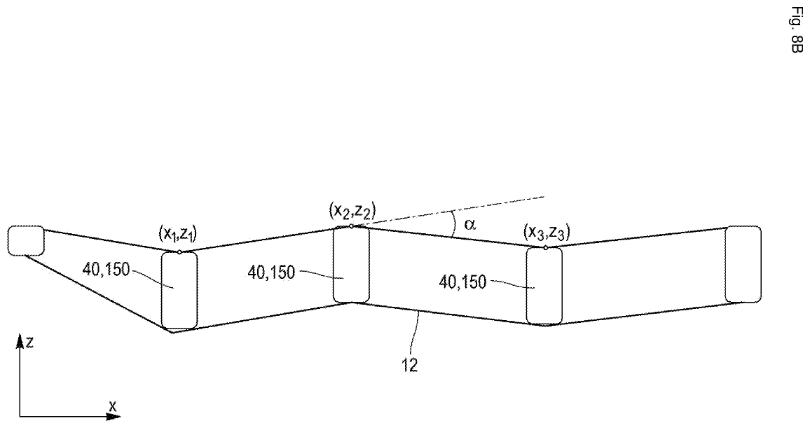

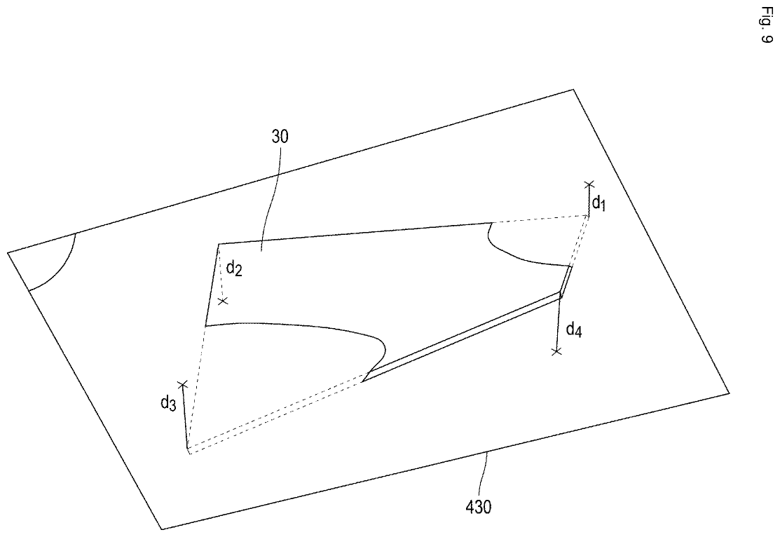

After steps 401 and 402, the method 400 passes to a step 403 consisting in defining positioning lines 100. The positioning lines 100 define locations 130 for the wall modules 30, as shown in FIG. 8A.

In the example shown in the figures, the positioning lines 100 comprise vertical positioning lines 110 and horizontal positioning lines 120 perpendicular to the vertical positioning lines 110, in such a way as to define locations 130 which are rectangular and correspond to the rectangular outer contour of the wall modules 30. According to a particular example, the vertical positioning lines 110 are determined by determining a vertical median vertical line of a planar facet 224, and by disposing the vertical positioning lines 110 at regular intervals along this vertical median vertical line. Equally, the horizontal positioning lines 120 are determined by determining a horizontal median horizontal line of a planar facet 224, and by disposing the horizontal positioning lines 120 at regular intervals along this horizontal median horizontal line.

After step 403, the method 400 passes to a step 404 consisting in defining setting lines 150 on the basis of the positions of the positioning lines 100. The setting lines 150 represent the positions of the spacer elements 40 in the final position 320. The setting lines 150 are disposed such that at least one setting line 150 intersects each of the locations 130 for the wall modules 30.

In the example shown in the figures, the setting lines 150 are disposed such that at least four setting lines 150 intersect each of the rectangular locations 130 in the vicinity of the corners of these rectangular locations. However, a different number of setting lines 150 may be provided, notably when spacer elements 40 are disposed somewhere other than in the vicinity of the corners of the rectangular locations 130.

After step 404, the method passes to a step 405 consisting in calculating initial dimensions of the setting lines 150 on the basis of the position measurements of the vertical load-bearing wall 12 obtained in step 401, and then in iteratively decreasing the dimensions of the setting lines 150 so as to bring the wall modules 30 closer to the vertical load-bearing wall 12. This iterative decrease is carried out under the constraint of acceptability criteria comprising planarity criteria limiting deformations of the planar facets 224.

In certain variants, during step 405, the dimensions of the setting lines 150 are iteratively decreased by a predetermined increment δ.

Steps 403, 404 and 405 are carried out for each of the planar facets 224.

A possible implementation of step 405 and examples of acceptability criteria will now be described in detail with reference to FIGS. 4B to 10.

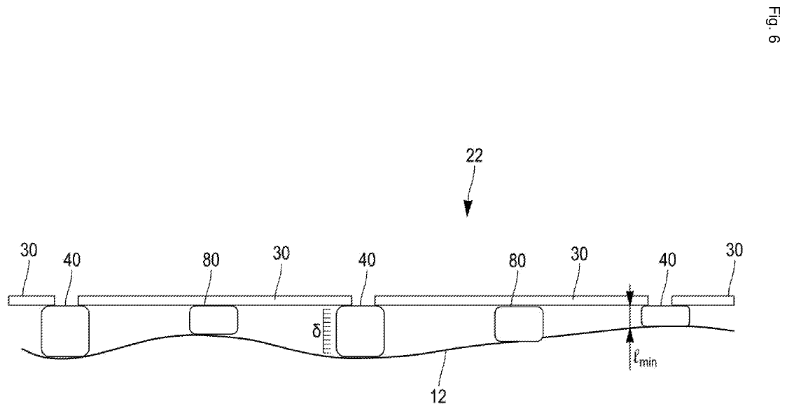

In a step 500, the heights of the setting lines 150 are initialized such that the acceptability criteria are verified. According to a particular example shown schematically in FIG. 5, the dimensions of the setting lines 150 are initialized in the following manner. The setting line 150-1 at which the vertical load-bearing wall 12 is closest to the planar facet 224 is identified, and the dimension of this setting line 150-1 is set to the minimum dimension lₘᵢₙ discussed below in relation to step 503. The dimensions of the other setting lines 150 are then set such that the acceptability criteria are verified.

After the initialization in step 500, the method passes to a step 501 which consists in selecting a setting line 150.

In a step 502, the dimension of the setting line 150 selected in step 501 is decreased by the increment δ.

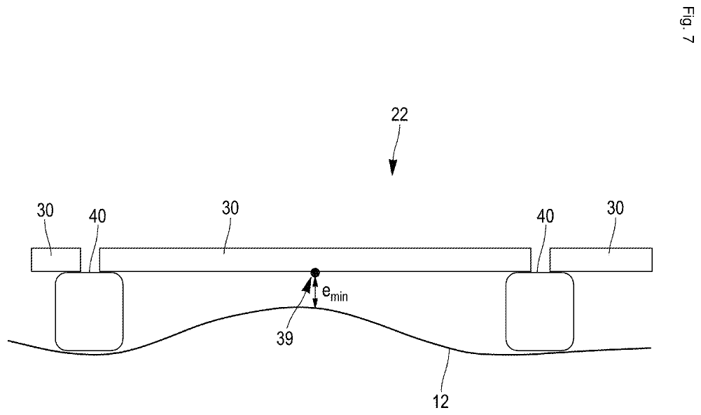

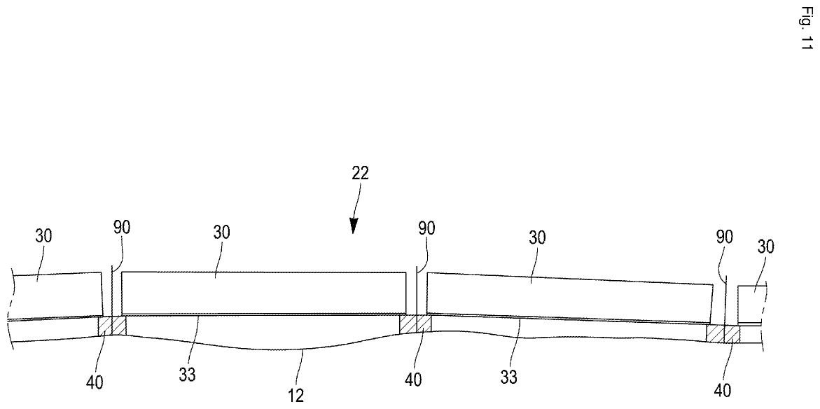

In a step 503, it is verified that the dimension of the setting line 150 decreased in step 502 meets a lower limit criterion according to which the dimension of this setting line 150 remains greater than the minimum dimension lₘᵢₙ. The minimum dimension lₘᵢₙ is set in advance. It may for example be a minimum dimension that it is possible to provide for a spacer element 40 whilst still allowing the spacer element 40 to be manufactured and used. FIG. 6 illustrates the minimum dimension lₘᵢₙ in the case where the spacer element 40 is a shim as described further below in relation to FIGS. 10 and 11. FIG. 6 also illustrates a multiplicity of increments δ.

In a step 504, it is verified that the dimension of the setting line 150 decreased in step 502 meets a spacing criterion according to which a distance between the wall module 30 to which it corresponds and the vertical load-bearing wall 12, perpendicularly with respect to this wall module 30, remains greater, at any point 39 along the lower edge of the wall module 30 for which a position measurement of the vertical load-bearing wall 12 obtained in step 401 is available, than a minimum spacing eₘᵢₙ. The minimum spacing eₘᵢₙ is set in advance. FIG. 7 schematically shows the minimum spacing eₘᵢₙ in the case where the spacer element 40 is a shim as described further below in relation to FIGS. 10 and 11.

In a step 505, it is verified that the dimension of the setting line 150 decreased in step 502 meets a slope criterion relating to the slope difference a between the apexes of three aligned neighboring spacer elements 40. More precisely, it is verified that this slope difference a remains lower than a threshold 2A, where A is a magnitude set in advance.

FIGS. 8A and 8B illustrate an example of the calculation of the slope criterion. The coordinates of the apexes of three aligned setting lines 150 being denoted by (x₁, z₁), (x₂, z₂), (x₃, z₃), in a Cartesian frame of reference (x, z) where x is parallel to a line 190 (see FIG. 8A) that connects these three setting lines 150, the slope criterion is verified if the following inequality is verified:

$$α = \vert \frac{{z}_{2} - {z}_{1}}{{x}_{2} - {x}_{1}} - \frac{{z}_{3} - {z}_{2}}{{x}_{3} - {x}_{2}} \vert \leq 2 A \qquad [ Math . 1 ]$$

In a step 506, it is verified that the dimension of the setting line 150 decreased in step 502 meets a torsion criterion relating to the spacings between the wall module 30 to which it corresponds, in line with spacer elements corresponding to this wall module 30, and a mean plane of said wall module, perpendicularly with respect to said wall module 30.

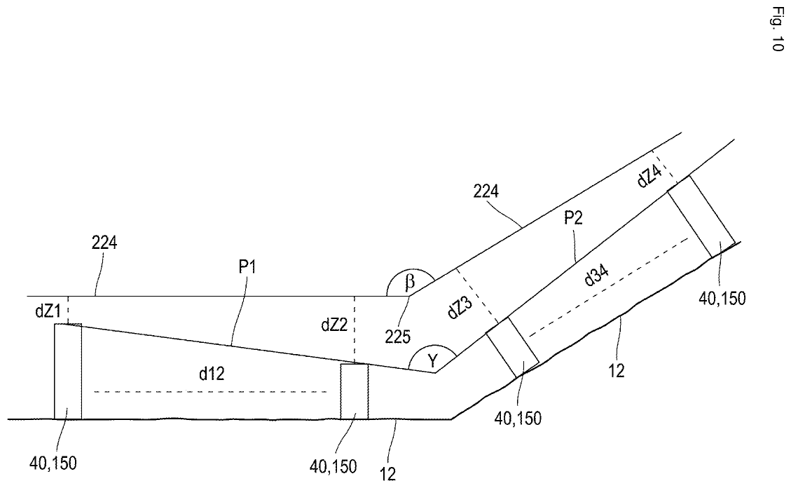

FIG. 9 illustrates an example of the torsion criterion. For a wall module 30 corresponding to several setting lines 150, it is possible to define a mean plane 430 of the wall module 30. The apexes of the setting lines 150 are at distances d₁, d₂, d₃, d₄ . . . from this mean plane 430. To facilitate the understanding of FIG. 9, it is specified that, in this figure, the apexes of the setting lines 150 which are separated from the mean plane 430 by the distances d₂ and d₄ are above the mean plane 430, whereas the apexes of the setting lines 150 which are separated from the mean plane 430 by the distances d₁ and d₃ are below the mean plane 430. The parts of the wall module 30 which are below the mean plane 430 are also represented in broken lines. The torsion criterion is considered to be verified if the quantity D=d₁+d₂+d₃+d₄+ . . . is lower than a predetermined threshold.

The acceptability criteria of steps 503 to 506 relate solely to the setting lines 150 corresponding to a single planar facet 224. However, it may also be desired to ensure that the dimensions of the setting lines 150 allow a sufficiently easy connection between two adjacent planar facets 224 separated by a corner edge 225, as shown in FIG. 10.

To this end, in step 402, a reference value β for the angle separating two planar facets 224 at a corner edge 225 is also defined (cf. FIGS. 1A and 10). This reference value β may be identical for all the corner edges 225.

In a step 507, an angle γ formed by two slopes P1, P2 connecting the apexes of the two aligned spacer elements 40 closest to the corner edge 225, on either side of said corner edge 225, is calculated, and it is verified whether the angle γ verifies an angle criterion. The angle criterion is considered to be verified if the angle γ is comprised within a range including the reference value β. The span of this range quantifies the difference that is acceptable between γ and β: the narrower this range, the more the planar facets 224 are constrained to form an angle γ which is close to the reference value β. By ensuring a higher uniformity of the angles between facets, the mechanical connection of the facets is facilitated, for example by the possibility of using standardized components.

FIG. 10 illustrates the angle γ and a way of calculating it. The distances between the apexes of the spacer elements 40 and the corresponding planar facet being denoted by dZ₁, dZ₂, dZ₃, dZ₄, and the distances separating the spacer elements 40 being denoted by d₁₂ and d₃₄, we have:

$$γ - β = {tan}^{- 1} \frac{{dZ}_{2} - {dZ}_{1}}{{d}_{12}} - {tan}^{- 1} \frac{{dZ}_{4} - {dZ}_{3}}{{d}_{34}} \qquad [ Math . 2 ]$$

The criterion of step 507 is considered to be verified if the absolute value of y-β is comprised within a predetermined range.

If one of the acceptability criteria of steps 503 to 507 is not verified, the method passes to a step 508 in which the decrease of the setting line 150 carried out in step 502 is canceled. In other words, the setting line 150 selected in step 501 is restored to the dimension that it had prior to step 502.

If, on the contrary, all of the acceptability criteria of steps 503 to 507 are verified, the method passes to a step 509 in which the decrease of the setting line 150 carried out in step 502 is validated.

After step 508 or 509, the method passes to a step 510 in which it is verified whether there is still a setting line 150 that has not been selected.

If so, the method passes to a step 511 in which a setting line 150 that has not yet been selected is selected, after which steps 502 to 510 are repeated for this setting line 150. The selection in step 511 of a setting line 150 that has not yet been selected may be effected in various ways. According to one variant, this selection is completely random. According to another variant, this selection is limited to the setting lines 150 of a single planar facet 224; in other words, in step 511, selection of setting lines 150 corresponding to a given planar facet 224 is continued as long as there are still setting lines 150 that have not yet been selected on this planar facet 224.

If not, the method passes to a step 512 in which it is verified whether the decrease of the dimension has been validated in step 508 for at least one setting line 150. It will be understood that if this verification is negative, it is no longer possible to further decrease the dimensions of the setting lines 150 without violating the acceptability criteria of steps 503 to 507; the method therefore passes to a step 513 in which the dimensions of the setting lines 150 are recorded in a memory as dimensions of the spacer elements 40. It will be understood that if, on the contrary, this verification is positive, it is still potentially possible to decrease the dimensions of some of the setting lines 150 without violating the acceptability criteria of steps 503 to 507; the method therefore returns to step 501 in order to again select a setting line 150 and repeat steps 502 to 509.

In a variant, only some of the acceptability criteria of steps 503 to 507 may be used.

The steps of the calculation method 400 may be implemented by a suitable computer program executed by a computer. The position measurements obtained in step 401 may be fully or partly input manually by a user, or may be provided to the computer program in a computer-readable format.

The principles above can be applied to numerous types of tank wall comprising planar wall modules and spacer elements disposed between the planar wall modules and a load-bearing wall. Two embodiment variants of such tank walls will be described below.

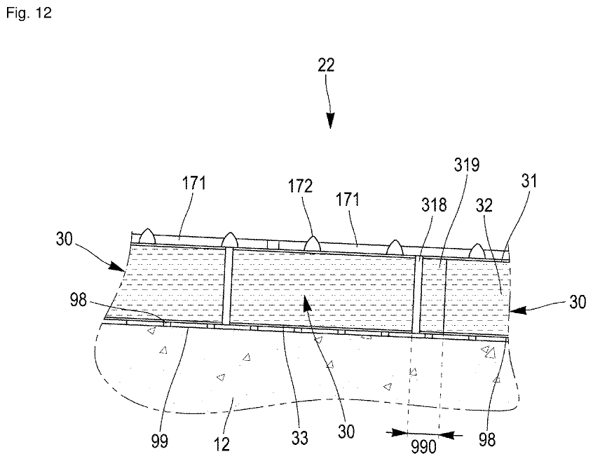

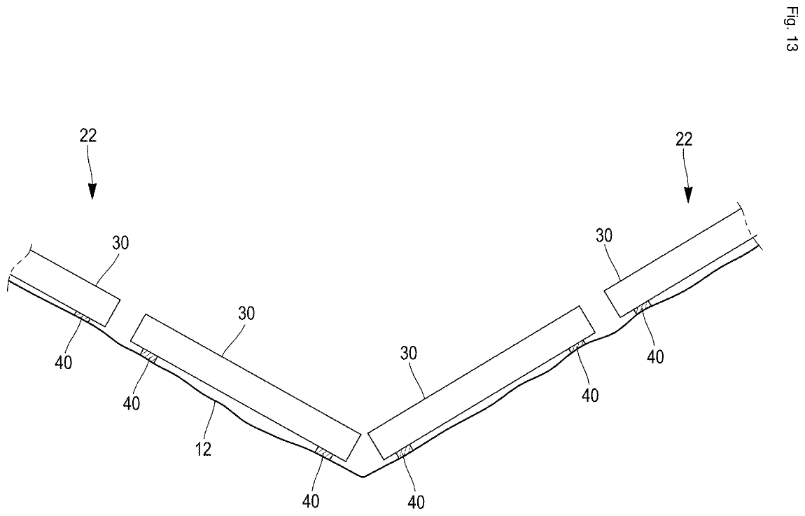

FIGS. 11 to 13 show a first embodiment variant of the vertical peripheral wall 22. In this variant, the spacer elements 40 take the form of shims. FIG. 12 is a view in section of the wall modules 30 at their centers and therefore does not show the shims 40.

The wall modules 30 take the form of thermally insulating blocks of parallelepipedal overall shape. The blocks 30 are anchored on the vertical load-bearing wall 12 at their corners by anchoring members, the positions of which are indicated by the references 90 in FIG. 10. The shims 40 are arranged on these anchoring members, or in the vicinity of these anchoring members. Furthermore, the shims 40 are arranged under the blocks 30. The variable dimensions of the shims 40 thus make it possible to compensate for the planarity defects of the vertical load-bearing wall 12.

FIG. 12 shows the structure of the blocks 30 in a more precise manner. The blocks 30 comprise a block 32 of polymer foam, for example made of polyurethane foam, optionally reinforced with glass fibers and possibly having a density of between 130 and 200 kg/m³. The block 32 is sandwiched between a cover sheet 31 and a bottom sheet 33, which are for example made of plywood.

It can also be seen in FIG. 12 that glass wool plugs 318 and/or blocks of polyurethane foam 319 may be disposed between the blocks 30 in order to fill the gaps 990 created between said blocks. Furthermore, beads of mastic 98 may potentially be disposed between the blocks 30 and the vertical load-bearing wall 12. A coating 99, for example made of polymer, may have been applied to the surface of the vertical load-bearing wall 12 prior to the fitting of the blocks 30 and the shims 40.

Metal sheets 171 are disposed above the blocks 30 and are welded by their edges according to the known technique in order to constitute a sealed membrane. In a manner that is not shown, the edges of the metal sheets 171 may be welded to metal anchor plates that bear the cover sheets 31 of the blocks 32 in order to retain the metal sheets 171 on the cover sheets 31. The metal sheets 171 may have corrugations 172 in order to absorb the thermal contraction phenomena caused by the contact with a cold liquid product, such as LNG.

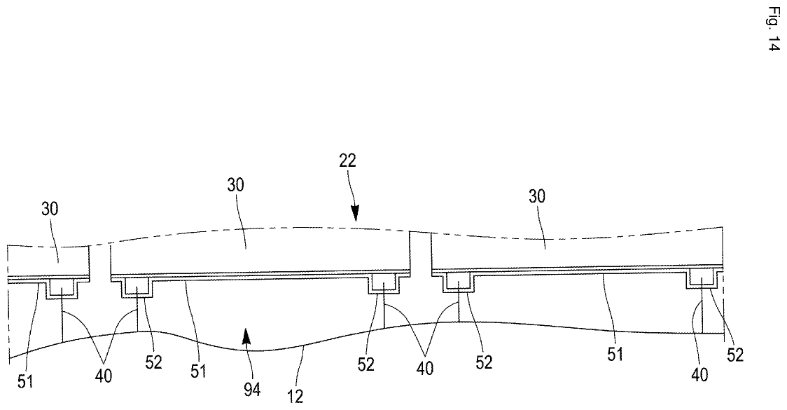

FIG. 13 shows part of the vertical peripheral wall 22 at an angle between two of its planar facets. The angles of the vertical peripheral wall 22 are solely materialized by a junction (not shown) between two adjacent blocks 30.

The arrangement of the shims 40 under the blocks 30 shown in FIG. 10 is only an example. The shims 40 could be disposed differently with respect to the blocks 30; for example a shim 40 could be disposed under each corner of each block 30.

Furthermore, additional shims 80 may be disposed under each block 30, between the locations of the shims 40, as shown in FIG. 6. The dimensions of these additional shims 80 may be calculated on the basis of the dimensions of the shims 40 calculated by the calculation method 400 and of the position measurements obtained in step 401.

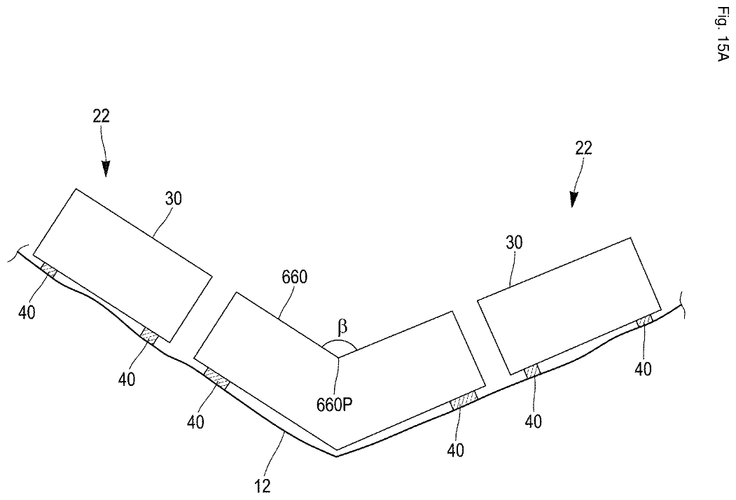

Furthermore, the spacer elements 40 may take forms other than shims. Purely by way of illustration, FIG. 14 schematically shows a second embodiment variant of the vertical peripheral wall 22 in which the spacer elements 40 take the form of anchor rods. The wall modules 30 take the form of planar panels of parallelepipedal overall shape. In a manner that is not shown, metal sheets are disposed above the wall modules 30 and are welded by their edges according to the known technique in order to constitute a sealed membrane. For example the metal sheets may be welded to anchor plates comprised by the wall modules 30.

Each panel 30 comprises in this case a rectangular fastening sheet 51 which is anchored, at each of its corners, by the anchor rods 40. To this end, the fastening sheet 51 has counterbores 52 at its corners. Those ends of the anchor rods 40 which are opposite the vertical load-bearing wall 12 are received in through-holes (not shown) comprised by the bottoms of the counterbores 52. The anchor rods 40 may thus be fastened to the bottom of the counterbores 52 by anchoring means (not shown) which keep each panel 30 in abutment in the direction of the vertical load-bearing wall 12. After the panels 30 have been installed on the vertical load-bearing wall 12, it is possible for a cement slurry or other similar material to be injected into the space 94 left between the panels 30 and the vertical load-bearing wall 12 in order to ensure the mechanical strength of the vertical peripheral wall 22 on the vertical load-bearing wall 12.

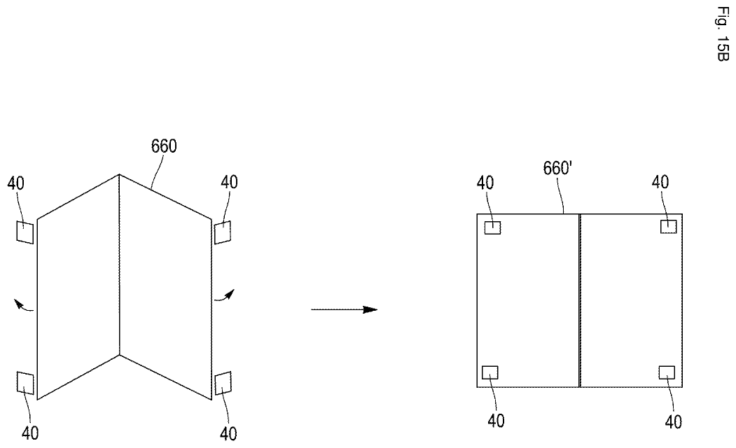

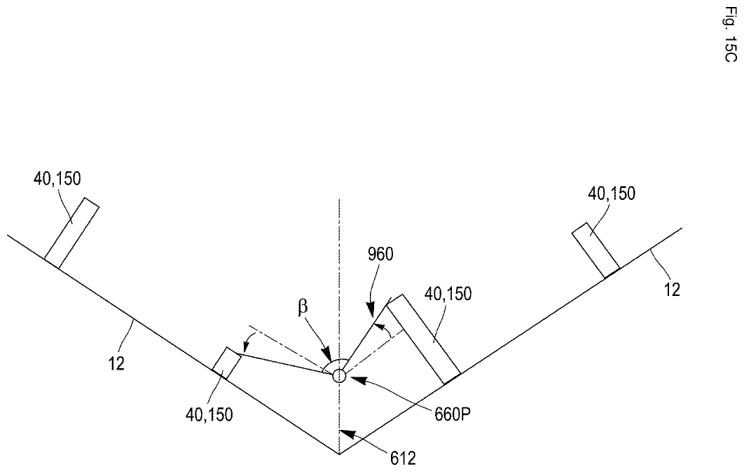

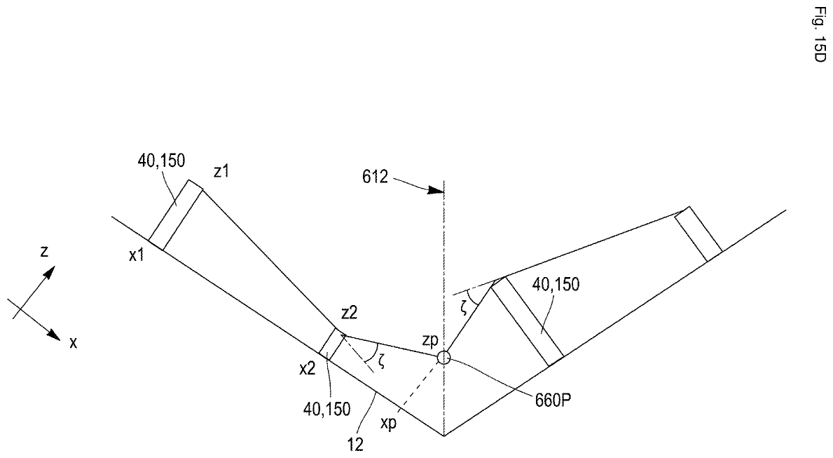

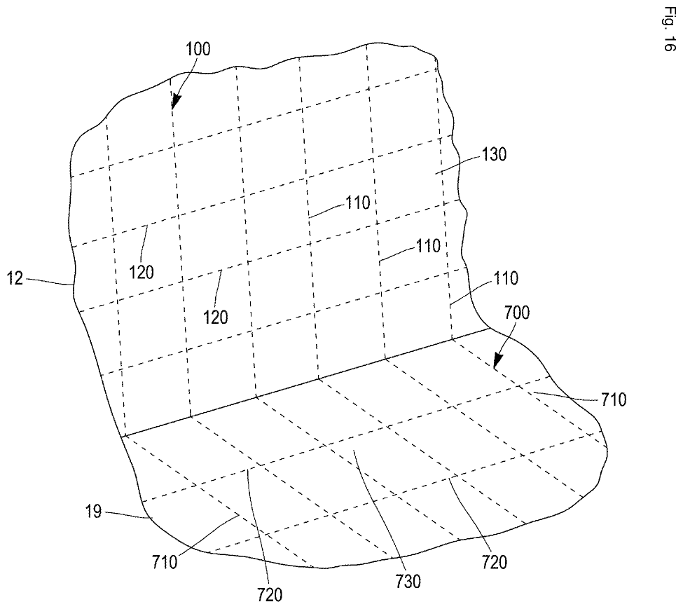

A description has just been given here of a vertical peripheral wall 22 which is produced exclusively by juxtaposing wall modules 30 which are planar. However, as shown in FIG. 15A, in a variant the vertical peripheral wall 22 may comprise dihedral blocks 660 disposed between the planar wall modules 30. The dihedral blocks 660 exhibit a dihedron of angle β, where β is the reference value discussed above. Spacer elements 40, in this case shims, are also disposed between these dihedral blocks 660 and the vertical load-bearing wall 12. The principles described above can also be applied to a vertical peripheral wall 22 produced in this way, with the condition of taking account of the presence of the dihedral blocks 660 by modifying the calculation method 400 in the following way:

In step 506, the torsion criterion described above is adapted for the setting lines 150 which correspond to the spacer elements 40 corresponding to the dihedral blocks 660. For these setting lines 150, in order to calculate the mean plane 430, the apexes of two setting lines 150 situated on the same side of the dihedron of the dihedral block 660 are virtually displaced by a rotation intended to virtually transform the dihedral block 660 into a planar virtual block 660′, as shown in FIG. 15B. The torsion criterion is then verified by means of the mean plane 430 as has been explained above in relation to FIG. 10.

The angle criterion of step 507 is not verified; instead of this, solely for the setting lines 150 which correspond to the spacer elements 40 corresponding to the dihedral blocks 660, it is verified in step 507 whether a slope criterion specific to the dihedral blocks 660 is verified. This slope criterion relates to the slope difference ζ between:
on the one hand, a slope between the apex of the spacer element 40 corresponding to the dihedral block 660 and the apex of the adjacent spacer element 40, and
on the other hand, a slope between the apex of the spacer element 40 corresponding to the dihedral block 660 and a point 660P situated on the dihedron of the dihedral block 660 and aligned with these spacer elements 40 (cf. FIGS. 15A, 15C and 15D). More precisely, it is verified that this slope difference ζ remains lower than a threshold 2B, where B is a magnitude set in advance. B is preferably selected to be equal to A in order to facilitate the connection between the dihedral block 660 and the planar wall modules 30.

FIGS. 15C and 15D illustrate an example of the calculation of the slope criterion specific to the dihedral blocks 660. First of all, with reference to FIG. 15C, the position of the point 660P is calculated: it is located at the intersection of the bisector 612 of the reference angle β with the position 960 of the dihedral block 660 taking account of the heights of the spacer elements 40 which correspond to said block. Then, with reference to FIG. 15D, the coordinates of the point 660P and of the apexes of the two setting lines 150 aligned with this point being denoted respectively by (x₁, z₁) (x₂, z₂), (xₚ, zₚ), in a Cartesian frame of reference (x, z) where x is parallel to a line 190 (see FIG. 8A) that connects these two setting lines 150, the slope criterion specific to the dihedral blocks 660 is verified if the following inequality is verified:

$$ζ = \vert \vert \frac{{z}_{2} - {z}_{1}}{{x}_{2} - {x}_{1}} - \frac{{z}_{p} - {z}_{2}}{{x}_{p} - {x}_{2}} \vert \leq 2 B \qquad [ Math . 3 ]$$

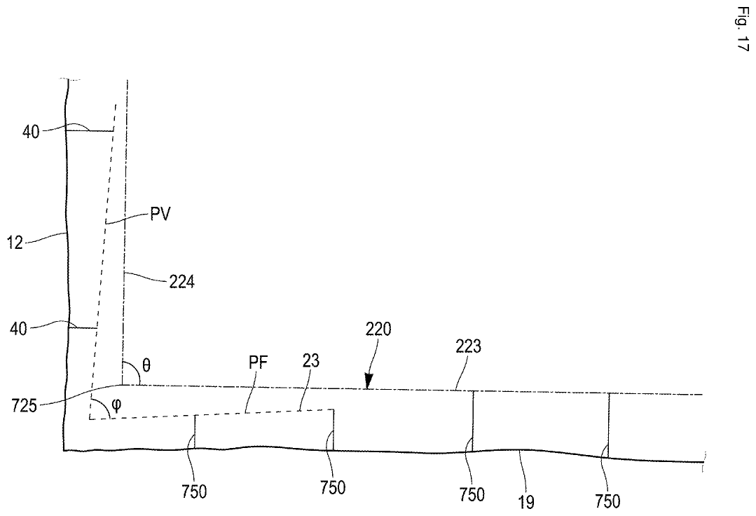

The principles described above for the vertical peripheral wall 22 of the tank 20 can also be applied to a substantially planar bottom wall 23 of the tank 20, said bottom wall being disposed on a bottom load-bearing wall 19 of the load-bearing structure 10. Such a bottom load-bearing wall 19 is shown schematically in FIGS. 16 and 17.

As shown in FIG. 17, the bottom load-bearing wall 19 may exhibit dimensional deviations with respect to a planar ideal shape. These dimensional deviations may, for example, be due to dimensional tolerances on a concrete construction.

FIG. 17 also outlines the position of the bottom wall 23 of the tank 20 in dashed lines. Like the vertical peripheral wall 22, the bottom wall 23 of the tank 20 is formed of juxtaposed planar wall modules (not shown), which may be identical to the planar wall modules 30 constituting the vertical peripheral wall 22; and spacer elements (not shown), which may be identical to the spacer elements 40 of the vertical peripheral wall 22, are disposed between the wall modules and the bottom load-bearing wall in order to compensate for the aforementioned dimensional deviations.

Like for the vertical peripheral wall 22, the spacer elements should be provided with the smallest possible dimensions, in order to maximize the internal volume of the tank and to minimize the quantity of material to be disposed between the bottom load-bearing wall 19 and the bottom wall 23, whilst still ensuring that the bottom wall 23 has a sufficient planarity for supporting a sealed membrane sealing the tank 20.

To this end, the calculation method 400 is modified in the following way:
in step 401, the position measurements obtained include position measurements of the bottom load-bearing wall 19 in three dimensions;
in step 402, an initial position of the bottom wall 23 is also defined in the internal space 11. This initial position is defined by a bottom planar facet 223 (cf. FIG. 17);
in step 403, positioning lines 700 (cf. FIG. 16) defining locations 730 for the wall modules of the bottom wall 23 are also defined. According to one embodiment example, the positioning line 700 are defined on the basis of the positioning lines 100. For example, as shown in FIG. 16, the positioning lines 700 comprise first positioning lines 710 which are extensions of the vertical positioning lines 110 on the bottom load-bearing wall 19, and second positioning lines 720 which are each orthogonal to the first positioning lines 710;
in step 404, setting lines 750 are also defined (cf. FIG. 17). The setting lines 750 represent the positions of the spacer elements of the bottom wall 23 in its final position, and, like the setting lines 150, are disposed such that at least one setting line 750 intersects each of the locations for the wall modules of the bottom wall 23;
in step 405, initial dimensions of the setting lines 750 are also calculated on the basis of the position measurements of the bottom load-bearing wall 19 obtained in step 401, and the dimensions of the setting line 750 are iteratively decreased so as to bring the wall modules of the bottom wall 23 closer to the bottom load-bearing wall 19. This iterative decrease is carried out under the constraint of acceptability criteria comprising planarity criteria limiting deformations of the bottom planar facet 223.

To summarize the foregoing, the calculation method 400 defines and processes the setting lines 750 for the bottom wall 23 of the tank 20 together with the setting lines 150 for the vertical peripheral wall 22 of the tank 20.

The acceptability criteria for the setting lines 750 are similar, or even identical, to those already discussed above for the setting lines 150. They are therefore not described in detail again.

However, it is specified that, in order to allow a sufficiently easy connection between the bottom planar facet 223 and the planar facets 224, a reference value θ for the angle separating the bottom planar facet 223 and each planar facet 224 is defined. This reference value θ may be identical for each of the corner edges 725 separating the bottom planar facet 223 from a planar facet 224.

The angle criterion already described above in relation to step 507 and FIG. 10 consists, for the corner edges 725, in calculating an angle q formed by two slopes PF, PV (cf. FIG. 17) connecting the apexes of the two aligned spacer elements closest to the corner edge 725, and in verifying whether the angle q is comprised within a range including the reference value θ.

In a variant, the connection between the bottom planar facet 223 and the planar facets 224 may be produced by means of dihedral blocks, analogously to what has been described above in relation to FIGS. 15A to 15D. In this case, the slope criterion specific to the dihedral blocks that has already been described above in relation to FIGS. 15A to 15D is verified for the setting lines 150 and 750 corresponding to these dihedral blocks.

Although the invention has been described in connection with several particular embodiments, it is quite obvious that it is in no way limited thereto and that it comprises all the technical equivalents of the means described and also their combinations, if these fall within the scope of the invention.

The use of the verb “have”, “comprise” or “include” and of the conjugated forms thereof does not exclude the presence of elements or steps other than those set out in a claim.

In the claims, any reference sign between parentheses should not be understood as a limitation of the claim.

1. A calculation method (400) for calculating dimensions of spacer elements (40) intended for the construction of a liquid-product storage facility (1), the storage facility (1) comprising a load-bearing structure (10) having an internal space (11) delimited by a load-bearing wall (12) and a sealed tank (20) installed in the internal space (11) of the load-bearing wall (12), the calculation method (400) being implemented by computer and comprising:
obtaining (401) position measurements of the load-bearing wall (12) in three dimensions;
on the basis of said position measurements, defining (402), in the internal space (11) of the load-bearing structure (12), an initial position of the tank (20), the initial position of the tank comprising an initial position (220) for the peripheral wall (22) of the tank (20), the peripheral wall (22) having, in the initial position (220), a plurality of planar facets (224) forming a polygonal cylindrical surface having as directrix a convex polygon and a generatrix perpendicular to the directrix; and
for each planar facet (224):
defining (403) positioning lines (100) defining locations (130) of juxtaposed wall modules (30, 660) intended to form the peripheral wall (22) of the tank (20);
on the basis of the positions of the positioning lines (100), defining (404) setting lines (150) extending perpendicularly with respect to the planar facet (224) between the planar facet (224) and the load-bearing wall (12), the setting lines (150) being disposed such that at least one setting line (150) intersects each of the locations (130) of the wall modules (30, 660), said setting lines (150) representing the positions of spacer elements (40) intended to be disposed between each wall module (30, 660) and the load-bearing wall (12) in a final position of the peripheral wall (22) of the tank (20);
calculating (405) initial dimensions of the setting lines (150) on the basis of the position measurements of the load-bearing wall (12); and
iteratively decreasing (405) the dimensions of the setting lines (150) so as to bring the wall modules (30, 660) closer to the load-bearing wall (12) up to the final position of the peripheral wall (22) of the tank (20), the iterative decrease being carried out under the constraint of acceptability criteria, the acceptability criteria comprising planarity criteria limiting deformations of the planar facets (224).

2. The calculation method (400) as claimed in claim 1, wherein iteratively decreasing (405) the dimensions of the setting lines comprises:
a) selecting (501, 510) a setting line (150);
b) decreasing (502) the dimension of the selected setting line (150) down to a reduced dimension;
c) verifying by the calculation (503, 504, 505, 506) that the acceptability criteria are verified, and: if so, maintaining (508) the reduced dimension obtained in step b); if not, canceling (507) the decrease in dimension carried out in step b); and
d) verifying (509) whether there is at least one setting line that has not yet been selected, and if so, carrying out steps a) to c) on a said setting line that has not yet been selected; if not, verifying (511) whether the reduced dimension has been maintained in step c) for at least one setting line, and: if so, carrying out steps a) to d) again; if not, recording in a memory (512) the dimensions of the setting lines (150) as dimensions of the spacer elements (40).

3. The calculation method (400) as claimed in claim 1, wherein the dimensions of the setting lines (150) are decreased by a predetermined increment (8).

4. The calculation method (400) as claimed claim 1, wherein the acceptability criteria comprise a lower limit criterion according to which the dimensions of the setting lines (150) remain greater than or equal to a first predefined lower limit (lmin).

5. The calculation method (400) as claimed in claim 1, wherein the acceptability criteria comprise a spacing criterion according to which a distance between each wall module (30, 660) and the load-bearing wall (12), perpendicularly with respect to said wall module (30, 660), remains greater than or equal to a second predefined lower limit (emin).

6. The calculation method (400) as claimed in claim 1, wherein the acceptability criteria comprise a slope criterion relating to a slope difference (α) between the apexes of three aligned neighboring spacer elements (40).

7. The calculation method (400) as claimed in claim 1, wherein the acceptability criteria comprise a torsion criterion relating to the spacings between each wall module (30, 660) in line with the spacer elements (40) and a mean plane (430) of said wall module (30, 660), perpendicularly with respect to said wall module (30, 660).

8. The calculation method (400) as claimed in claim 1, wherein defining (402) said initial position (220) of the peripheral wall of the tank comprises defining reference values for angles (B) formed by said planar facets (224) at corner edges (225) separating said planar facets (224).

9. The calculation method (400) as claimed in claim 8, wherein the peripheral wall (22) of the tank (20) is completely formed of juxtaposed planar wall modules (30), and wherein the acceptability criteria comprise an angle criterion according to which an angle (γ) formed by two slopes connecting the apexes of the two aligned spacer elements (40) closest to a corner edge (225), on either side of said corner edge (225), is comprised within a range including the reference value for the angle (β) at said corner edge (225).

10. The calculation method (400) as claimed in claim 8, wherein the wall modules comprise, at one of said corner edges (225), dihedral wall modules (660) that are disposed at said corner edge (225) and exhibit a dihedron, the angle of which is equal to the reference value for the angle (β) at said corner edge (225), and wherein the acceptability criteria comprise a second slope criterion relating to a slope difference (ζ) between, on the one hand, a slope between the apex of a spacer element (40) corresponding to the dihedral block (660) and the apex of an adjacent spacer element (40), and, on the other hand, a slope between the apex of said spacer element (40) corresponding to the dihedral block (660) and a point (660P) situated on the dihedron of the dihedral block (660) and aligned with said spacer elements (40).

11. The calculation method (400) as claimed in claim 1, wherein:
the load-bearing structure (10) further comprises a planar bottom load-bearing wall (19) having dimensional tolerances;
obtaining (401) position measurements of the load-bearing wall (12) in three dimensions further comprises obtaining position measurements of the bottom load-bearing wall (19) in three dimensions;
the initial position of the tank (20) further comprises a bottom planar facet (223) defining an initial position for a bottom wall (23) of the tank (20);
the calculation method (400) further comprises:
defining, on the basis of the positioning lines (100), bottom positioning lines (700) defining locations of juxtaposed bottom wall modules (30) intended to form the bottom wall (23) of the tank (20);
on the basis of the positions of the bottom positioning lines (700), defining bottom setting lines (750) extending perpendicularly with respect to the bottom planar facet (223) between the bottom planar facet (223) and the bottom load-bearing wall (19), the bottom setting lines (750) being disposed such that at least one bottom setting line (750) intersects each of the locations (730) of the bottom wall modules (30), said bottom setting lines (750) representing the positions of spacer elements (40) intended to be disposed between each bottom wall module (30) and the bottom load-bearing wall (19) in a final position of the bottom wall (23) of the tank (20);
calculating initial dimensions of the bottom setting lines (750) on the basis of the position measurements of the bottom load-bearing wall (19); and
iteratively decreasing the dimensions of the bottom setting lines (750) so as to bring the wall modules (30) closer to the bottom load-bearing wall (19) up to the final position of the bottom wall (23) of the tank (20), the iterative decrease being carried out under the constraint of acceptability criteria, the acceptability criteria comprising planarity criteria limiting deformations of the bottom planar facet (223).

12. The calculation method (400) as claimed in claim 1, wherein the wall modules (30) intended to form the peripheral wall (22) of the tank (20) have a rectangular outer contour, the positioning lines (100) define rectangular locations (130) for the wall modules, and the setting lines (150) are disposed such that at least four setting lines (150) intersect each of the rectangular locations (130) of the wall modules (30) in the vicinity of the corners of the rectangular locations (130).

13. The calculation method (400) as claimed in claim 1, wherein the peripheral wall (22) of the tank (20) has, in the initial position (220), a plurality of planar facets (224) forming a polygonal cylindrical surface having as directrix a regular convex polygon.

14. The calculation method (400) as claimed in claim 1, wherein the load-bearing wall (12) forms a polygonal or circular cylindrical surface having dimensional tolerances.

15. The calculation method (400) as claimed in claim 1, wherein the spacer elements (40) comprise shims.

16. The calculation method (400) as claimed in claim 1, wherein the spacer elements (40) comprise anchor rods.
